(19) United States
(12) Patent Application Publication
(10) Pub. No.: US 2026/0361912 A1
(43) Pub. Date: Nov. 12, 2026

(54) DYNAMIC STRUCTURES FOR VOLUMETRIC DATA CODING

(71) Applicant: InterDigital CE Patent Holdings, SAS, Paris (FR)

(72) Inventors: Edouard FRANCOIS, Cesson-Sevigne (FR); Franck GALPIN, Cesson-Sevigne (FR); Gaëlle MARTIN-COCHER, Toronto (CA); Bertrand CHUPEAU, Cesson-Sevigne (FR); Julien RICARD, Plouër-sur-Rance (FR)

(21) Appl. No.: 19/104,815

(22) PCT Filed: Sep. 10, 2023
(86) PCT No.: PCT/EP2023/074818

§ 371 Date: Feb. 19, 2025

(30) Foreign Application Priority Data
Sep. 19, 2022 (EP) 22306373.6

(51) Int. Cl. H04N 19/597; H04N 19/105; H04N 19/172; H04N 19/503; H04N 19/593; H04N 19/70

(52) U.S. Cl. CPC H04N 19/597; H04N 19/105; H04N 19/172; H04N 19/503; H04N 19/593; H04N 19/70

(57) ABSTRACT

Apparatuses and methods are disclosed including techniques for encoding dynamic volumetric data. Techniques disclosed include receiving a sequence of volumetric datasets representative of the dynamic volumetric data and encoding the sequence. The encoding of a volumetric dataset in the sequence includes generating patches including respective two-dimensional representations of the volumetric dataset, packing the patches into one or more dynamic subpictures associated with a video frame, and then encoding, by a two-dimensional video encoder, the one or more dynamic subpictures into a bitstream of a coded volumetric dataset.

### CROSS REFERENCE TO RELATED APPLICATIONS

This application claims the benefit of European Application No. EP22306373.6, filed on Sep. 19, 2022, which is incorporated herein by reference in its entirety.

### BACKGROUND

The coding of dynamic volumetric data, such as immersive content or point cloud data, involves the coding of intermediate two-dimensional (2D) video data, so-called atlases. These atlases contain patches of geometry data and texture data that are required for the three-dimensional (3D) reconstruction of the volumetric data. Recent standards for volumetric data coding-such as the MPEG immersive video (MIV) standard and the video-based point cloud compression (V-PCC) standard, developed by ISO/IEC MPEG-rely on the utilization of traditional 2D video encoders to encode the atlases. To that end, data structures used by 2D video encoders, such as subpictures (recently introduced by the VVC standard), can be used to contain the atlases that describe the volumetric data to be encoded. However, constraints on data structures, as defined in the standards that are followed by current 2D video encoders, limit the efficiency with which atlases can be coded.

### SUMMARY

Aspects disclosed in the present disclosure describe methods for encoding dynamic volumetric data. The methods comprise receiving a sequence of volumetric datasets representative of the dynamic volumetric data and encoding the sequence. For a volumetric dataset in the sequence, the encoding comprises: generating patches including respective two-dimensional representations of the volumetric dataset, packing the patches into one or more dynamic subpictures associated with a video frame, and then, encoding, by a two-dimensional video encoder, the one or more dynamic subpictures into a bitstream of coded video data. Also disclosed are methods for decoding the dynamic volumetric data. The methods comprise receiving a bitstream of coded video data, coding a sequence of volumetric datasets representative of the dynamic volumetric data and decoding the sequence. For a volumetric dataset in the sequence, the decoding comprises: decoding, by a two-dimensional video decoder, from the bitstream one or more dynamic subpictures associated with a video frame, extracting patches from the decoded one or more dynamic subpictures, the patches include respective two-dimensional representations of the volumetric dataset, and reconstructing, based on the patches, the volumetric dataset.

Aspects disclosed in the present disclosure describe an apparatus for encoding dynamic volumetric data. The apparatus comprises at least one processor and memory storing instructions. The instructions, when executed by the at least one processor, cause the apparatus to receive a sequence of volumetric datasets representative of the dynamic volumetric data and to encode the sequence. For a volumetric dataset in the sequence, the encoding comprises: generating patches including respective two-dimensional representations of the volumetric dataset, packing the patches into one or more dynamic subpictures associated with a video frame, and encoding, by a two-dimensional video encoder, the one or more dynamic subpictures into a bitstream of coded video data. Also disclosed an apparatus for decoding dynamic volumetric data. The apparatus comprises at least one processor and memory storing instructions. The instructions, when executed by the at least one processor, cause the apparatus to receive a bitstream of coded video data, coding a sequence of volumetric datasets representative of the dynamic volumetric data and to decode the sequence. For a volumetric dataset in the sequence, the decoding comprises: decoding, by a two-dimensional video decoder, from the bitstream one or more dynamic subpictures associated with a video frame, extracting patches from the decoded one or more dynamic subpictures, the patches include respective two-dimensional representations of the volumetric dataset, and reconstructing, based on the patches, the volumetric dataset.

Further aspects disclosed in the present disclosure describe a non-transitory computer-readable medium comprising instructions executable by at least one processor to perform methods for encoding dynamic volumetric data. The methods comprise receiving a sequence of volumetric datasets representative of the dynamic volumetric data and encoding the sequence. For a volumetric dataset in the sequence, the encoding comprises: generating patches including respective two-dimensional representations of the volumetric dataset, packing the patches into one or more dynamic subpictures associated with a video frame, and then, encoding, by a two-dimensional video encoder, the one or more dynamic subpictures into a bitstream of coded video data. Also disclosed a non-transitory computer-readable medium comprising instructions executable by at least one processor to perform methods for decoding dynamic volumetric data. The methods comprise receiving a bitstream of coded video data, coding a sequence of volumetric datasets representative of the dynamic volumetric data and decoding the sequence. For a volumetric dataset in the sequence, the decoding comprises: decoding, by a two-dimensional video decoder, from the bitstream one or more dynamic subpictures associated with a video frame, extracting patches from the decoded one or more dynamic subpictures, the patches include respective two-dimensional representations of the volumetric dataset, and reconstructing, based on the patches, the volumetric dataset.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to which aspects of the present embodiments can be implemented.

FIG. 2 is a block diagram of an example video encoder, according to which aspects of the present embodiments can be implemented.

FIG. 3 is a block diagram of an example video decoder, according to which aspects of the present embodiments can be implemented.

FIG. 4 is a block diagram of an example system for encoding dynamic volumetric data, according to which aspects of the present embodiments can be implemented.

FIG. 5 is a block diagram of an example system for decoding dynamic volumetric data, according to which aspects of the present embodiments can be implemented.

FIGS. 6A-C illustrate a texture atlas 6A, a corresponding occupancy atlas 6B, and a filled-in texture atlas 6C, according to which aspects of the present embodiments can be implemented.

FIG. 7 illustrates an example segmentation of a picture, according to which aspects of the present embodiments can be implemented.

FIG. 8 illustrates an atlas, including texture and geometry data, according to which aspects of the present embodiments can be implemented.

FIG. 9 illustrates a point cloud representation, including occupancy, geometry, and texture atlases, according to which aspects of the present embodiments can be implemented.

FIG. 10 illustrates packing of geometry, texture, and occupancy atlases into respective subpictures of a video picture, according to which aspects of the present embodiments can be implemented.

FIG. 11 illustrates dynamic subpicture sizing, according to which aspects of the present embodiments can be implemented.

FIG. 12 illustrates a one-dimensional layout of subpictures, according to which aspects of the present embodiments can be implemented.

FIG. 13 illustrates subpicture dependency, according to which aspects of the present embodiments can be implemented.

FIG. 14 illustrates reference picture lists, according to which aspects of the present embodiments can be implemented.

FIG. 15 illustrates reference subpicture lists, according to which aspects of the present embodiments can be implemented.

FIG. 16 illustrates referencing to a block in a reference subpicture, according to which aspects of the present embodiments can be implemented.

FIG. 17 illustrates relative referencing to a block in a reference subpicture, according to which aspects of the present embodiments can be implemented.

FIG. 18 illustrates inter and intra referencing by a subpicture, according to which aspects of the present embodiments can be implemented.

FIG. 19 is a flowchart of an example method for encoding dynamic volumetric data, according to which aspects of the present embodiments can be implemented.

FIG. 20 is a flowchart of an example method for decoding dynamic volumetric data, according to which aspects of the present embodiments can be implemented.

### DETAILED DESCRIPTION

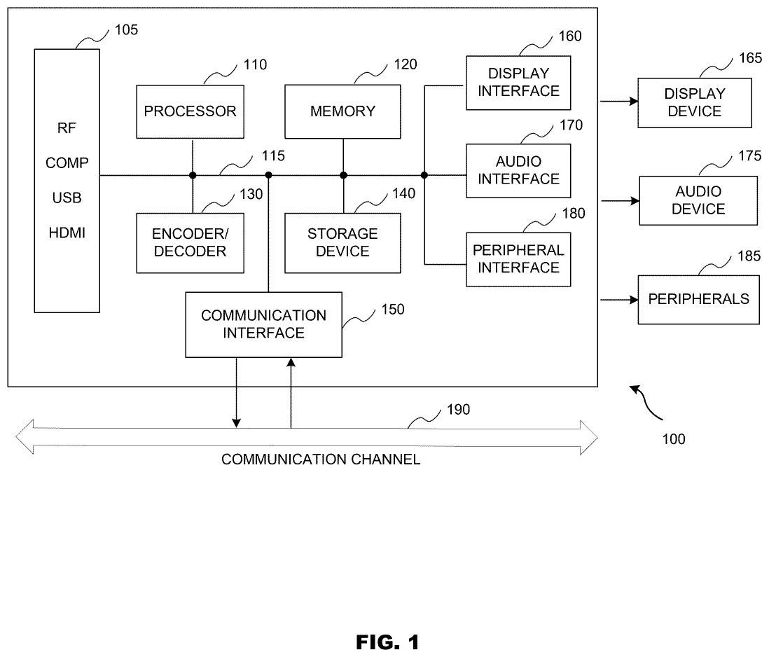

Traditional systems and methods for video coding of 2D video frames (video streams) are described next with reference to FIGS. 1-3.

FIG. 1 illustrates a block diagram of an example system 100. System 100 can be embodied as a device including the various components described below and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in a single integrated circuit, multiple integrated circuits, and/or discrete components. For example, in at least one embodiment, the processing and encoder/decoder elements of system 100 are distributed across multiple integrated circuits and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120 (e.g., a volatile memory device and/or a non-volatile memory device). System 100 includes a storage device 140, which can include non-volatile memory and/or volatile memory, including, for example, EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide an encoded video data or decoded video data. The encoder/decoder module 130 can include its own processor and memory. The encoder/decoder module 130 represents module(s) that can be included in a device to perform encoding and/or decoding functions. Additionally, encoder/decoder module 130 can be implemented as a separate element of system 100 or can be incorporated within processor 110 as a combination of hardware and software as known to those skilled in the art.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data are streamed to the system 100, in various embodiments, using a Wi-Fi network such as IEEE 802.11. The Wi-Fi signal of these embodiments is received over the communication channel 190 and the communication interface 150 which are adapted for Wi-Fi communications. The communication channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

The display device 165 and the audio device 175 can alternatively be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

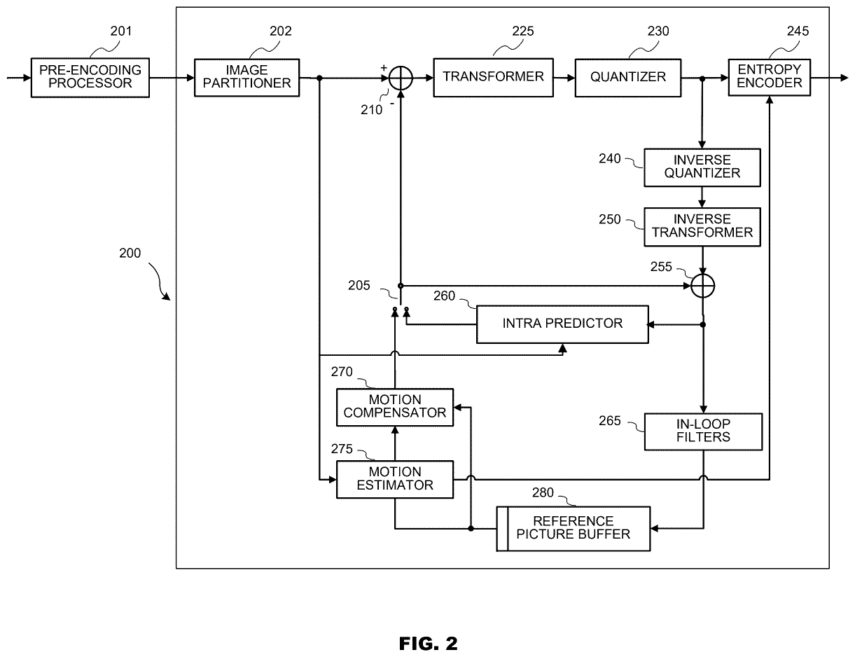

FIG. 2 illustrates a block diagram of an example video encoder 200. The video encoder 200 can be employed by the system 100 described in reference to FIG. 1. For example, the video encoder 200 can be an encoder that operates according to coding standards such as the Advanced Video Coding (AVC, H.264/MPEG-4|ISO/IEC 14496-10), the High Efficiency Video Coding (HEVC, ITU-T H.265|ISO/IEC 23008-2), or the Versatile Video Coding (VVC, ITU-T H.266 ISO/IEC 23090-3).

As shown in FIG. 2, prior to undergoing encoding, the video data can be pre-processed by a pre-encoding processor 201. Such pre-processing can include applying a color model transform to the input color picture (e.g., conversion from RGB 4:4:4 to YCbCr 4:2:0) or performing a mapping of the input picture's components in order to get a signal distribution that is more resilient to compression (for instance, applying a histogram equalizer and/or a denoising filter to one or more of the picture's components). The pre-processing can also include associating metadata with the video data that can be attached to the coded video bitstream.

In the encoder 200, a picture of a video frame is encoded by the encoder elements as generally described below. A picture to be encoded is partitioned into coding units (CUs) by an image partitioner 202. Typically, a CU contains a luminance block and respective chroma blocks, and so operations described herein as applied to a CU, applied with respect to the CU's luminance block and respective chroma blocks. Following partition 202, each CU can be encoded using an intra or inter prediction mode. In an intra prediction mode, an intra prediction is performed by an intra predictor 260. In the intra prediction mode, content of a CU in a frame is predicted based on content from one or more other CUs of the same frame, using the other CUs' reconstructed version. In an inter prediction mode, motion estimation and motion compensation are performed by a motion estimator 275 and a motion compensator 270, respectively. In the inter prediction mode, content of a CU in a frame is predicted based on content from one or more other CUs of neighboring frames, using the other CUs' reconstructed versions that can be fetched from the reference picture buffer 280. The encoder decides 205 which prediction result (the one obtained through operation in the intra prediction mode 260 or the one obtained through operation in inter prediction mode 270, 275) to use for encoding a CU, and indicates the selected prediction mode by, for example, a prediction mode flag. Following the prediction operation, residual data are calculated for each CU, for example, by subtracting 210 the predicted CU from the original CU.

The CUs' respective residual data are then transformed and quantized by a transformer 225 and a quantizer 230, respectively. Then, an entropy encoder 245 encodes the quantized transform coefficients, as well as motion vectors and other syntax elements, outputting a bitstream of coded video data. The encoder 200 can skip the transform operation 225 and quantize 230 directly the non-transformed residual data. The encoder 200 can bypass both the transform and the quantization operations, that is, the residual data can be coded directly by the entropy encoder 245.

The encoder 200 reconstructs the encoded CUs to provide a reference for future predictions. Accordingly, the quantized transform coefficients (output of the quantizer 230) are de-quantized, by an inverse quantizer 240, and then inverse transformed, by an inverse transformer 250, to decode the residual data of respective CUs. Combining 255 the decoded residual data with respective predicted CUs, results in respective reconstructed CUs. In-loop filters 265 can then be applied to the reconstructed picture (formed by the reconstructed CUs), to perform, for example, deblocking filtering and/or sample adaptive offset (SAO) filtering to reduce encoding artifacts. The filtered reconstructed picture can then be stored in the reference picture buffer (280).

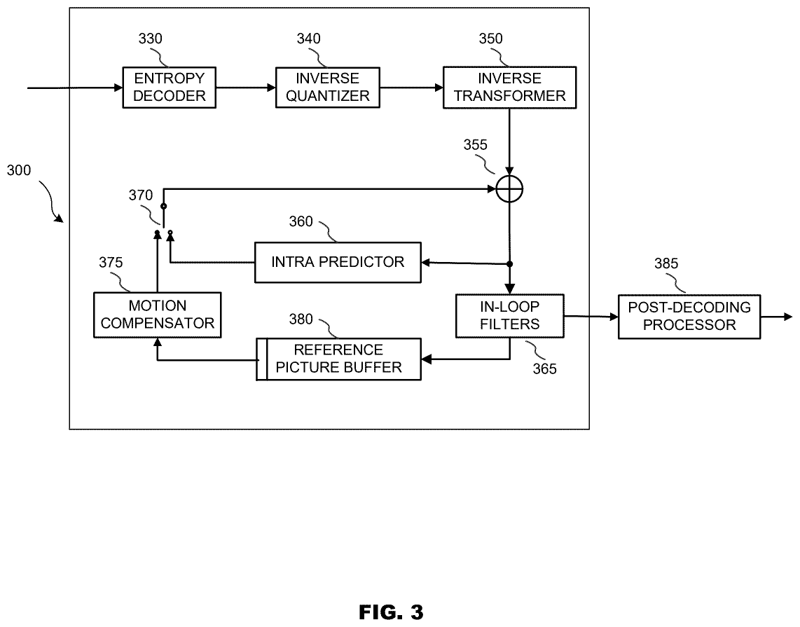

FIG. 3 illustrates a block diagram of an example video decoder 300. The video decoder 300 can be employed by the system 100 described in reference to FIG. 1. Generally, operational aspects of the video decoder 300 are reciprocal to operational aspects of the video encoder 200. As described in reference to FIG. 2, the encoder 200 also performs decoding operations 240, 250 through which the encoded pictures are reconstructed. The reconstructed pictures can then be stored in the reference picture buffer 280 and be used to facilitate motion estimation 275 and compensation 270, as explained above.

In the decoder 300, the bitstream of coded video data, generated by the video encoder 200, is first entropy decoded by an entropy decoder 330, decoding from the bitstream the quantized transform coefficients, motion vectors, and other control data that are encoded into the bitstream (such as data that indicate how the picture is partitioned and the CUs' selected prediction modes). The quantized transform coefficients are de-quantized, by an inverse quantizer 340, and then inverse transformed, by an inverse transformer 350, to decode the CUs respective residual data. Combining 355 the decoded residual data with respective predicted CUs, results in respective reconstructed CUs. Depending on a CU's selected prediction mode, a predicted CU can be obtained 370 from an intra predictor 360 or from a motion compensator 375. In-loop filters 365 can be applied to the reconstructed picture (formed by the reconstructed CUs). The filtered reconstructed picture can then be stored in a reference picture buffer 380 to facilitate the motion compensation 375.

A post-decoding processor 385 can further process the decoded picture. For example, post-decoding processing can include an inverse color model transform (e.g., conversion from YCbCr 4:2:0 to RGB 4:4:4) or an inverse mapping to reverse the mapping process performed in the pre-encoding processor 201. The post-decoding processor 385 can use metadata that were derived by the pre-encoding processor 201 and/or were signaled in the decoded video bitstream.

The introduction of immersive content of six degrees of freedom (where viewers have both translational and rotational freedom of movement and where motion parallax is supported) increased the amount of volumetric data required to describe a dynamic scene. Likewise, describing animated objects or 3D scenes by point clouds (that is, dynamic 3D surface points and respective attributes) requires large amount of volumetric data. To efficiently code dynamic volumetric data, the Visual Volumetric Video-based Coding (V3C) standard has been developed by the Motion Picture Experts Group (MPEG) (ISO/IEC 23090-5, 2021). The V3C standard provides a platform for coding different types of volumetric data-such as immersive content and point clouds, respectively specified by the MPEG immersive video (MIV, ISO/IEC 23090-12, 2021) and the video-based point cloud compression (V-PCC, ISO/IEC 23090-5, 2021) standards.

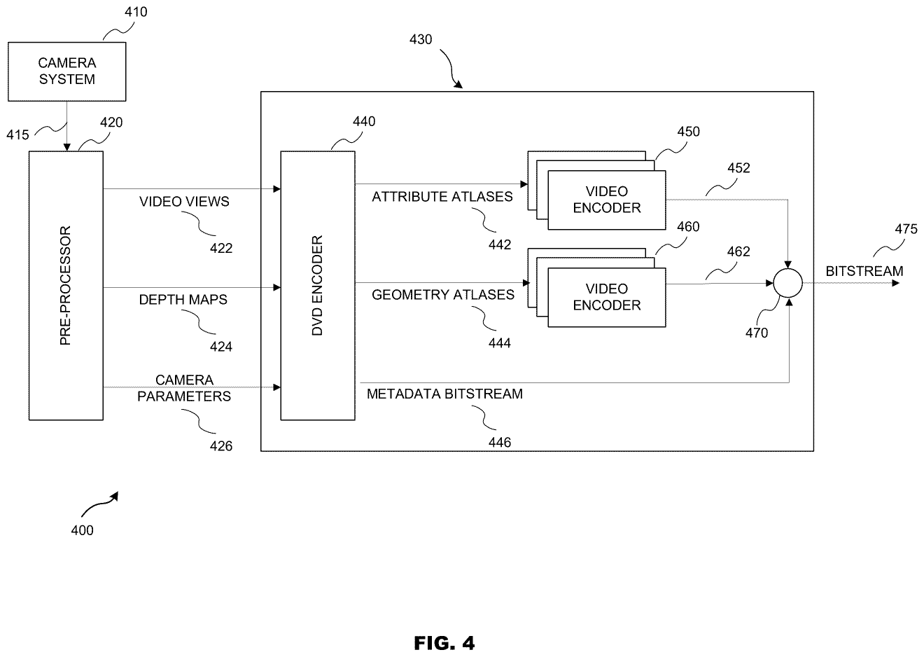

The MIV standard addresses the compression of data describing a (real/virtual) scene, captured by multiple (real/virtual) cameras. For further details, see J. M. Boyce et al., MPEG Immersive Video Coding Standard, Proceedings of the IEEE, vol. 109, no. 9, pp. 1521-1536 September 2021, DOI: 10.1109/JPROC.2021.3062590. The V-PCC standard addresses the compression of a dynamic point cloud sequence that can represent computer-generated objects for applications of virtual/augmented reality or can represent a surrounding environment to enable autonomous driving. For further details, see Graziosi, D. et al., An overview of ongoing point cloud compression standardization activities: Video-based (V-PCC) and geometry-based (G-PCC), APSIPA Transactions on Signal and Information Processing, Vol. 9, 2020, Ed. 13, DOI: 10.1017/ATSIP.2020.12. Encoding and decoding of dynamic volumetric data described herein (generally according to the above-mentioned standards) in reference to FIG. 4 and FIG. 5.

FIG. 4 is a block diagram of an example system 400 for encoding dynamic volumetric data. The system 400 includes a camera system 410 (including one or more cameras), a pre-processor 420, and an encoder 430. The one or more cameras of the camera system 410 may be real cameras and/or virtual cameras that are configured to capture a real-world scene and/or a virtual scene from multiple views, generating respective video streams. Image content captured in each of the video streams is a projection of the scene onto a projection plane of the respective camera. The camera system 410 can include other sensors configured, for example, to measure depth data for a respective video stream. Data associated with the multiple views 415, including the captured video streams (and, optionally, respective depth data) are fed to the pre-processor 420 together with the cameras' parameters (e.g., intrinsic and extrinsic camera parameters). The preprocessor 420 processes the data associated with the multiple views 415 and generates therefrom respective depth maps. For example, a depth map associated with a video frame captured by a camera contains distance values between a point at the scene and its projection at the camera's projection plane. The pre-processor 420 provides video views 422 (the captured video streams) as well as corresponding depth maps 424 and cameras' parameters 426 to the encoder 430 to generate therefrom a bitstream 475 of coded video data.

The encoder 430 includes a dynamic volumetric data (DVD) encoder 440, sets of traditional video encoders 450, 460, and a multiplexer 470. The DVD encoder 440 generates attribute 442 and geometry 444 atlases based on the provided video views 422, depth maps 424, and camera parameters 426. A geometry atlas contains geometry patches, each of which describes spatial data associated with content captured in a video view 422 and its corresponding depth map 424—for example, a geometry patch in a geometry atlas 444 may represent occupancy and depth data. An attribute atlas 442 contains attribute patches, each of which describes properties of content samples captured in a video view 422—for example, an attribute patch in an attribute atlas 442 may represent texture, transparency, surface normal, or reflectance data of the content samples. The DVD encoder 440 also codes metadata (using a coder defined by the MIV standard), generating a metadata bitstream 446. The metadata describe the atlases 442, 444 and the camera parameters 426.

By design, corresponding geometry patches and attribute patches, generated by the DVD encoder 440, together with the camera parameters 426, can be used for 3D reconstruction of the scene captured by the camera system 410. The main goal of the DVD encoder 440 is to generate 2D video data-containing one or more streams of attribute atlases 442 and corresponding one or more streams of geometry atlases 444. These video streams 442, 444, can then be encoded by the video encoders 450, 460, the operation of which is generally described in reference to FIG. 2. The outputs of the video encoders 452, 462 (that is, the bitstreams of coded video data) are then combined with the metadata bitstream 446 by the multiplexer 470, forming the output bitstream 475.

FIG. 5 is a block diagram of an example system 500 for decoding dynamic volumetric data. The system 500 includes a decoder 510 and a renderer 550. The decoder 510 generally reverses the operation of the encoder 430 of FIG. 4. The decoder 510 includes a de-multiplexer 520, sets of traditional video decoders 530, 540, and a DVD decoder 550. The de-multiplexer extracts the bitstreams of coded video data 522, 524 (i.e., 452, 462 of FIG. 4) and the metadata bitstream 526 (i.e., 446 of FIG. 4) from the received bitstream 505 (i.e., 475 of FIG. 4). The coded video data 522, 524 are then decoded, respectively, by the video decoders 530, 540, the operation of which is generally described in reference to FIG. 3. The video decoders 530, 540 recover the attribute atlases 532 and the geometry atlases 542 that together with the metadata bitstream 526 are fed into the DVD decoder 550. The DVD decoder 550 generates therefrom the video views 552 and their corresponding depth maps 554 and camera parameters 556. Using these data 552, 554, 556, the renderer 550 can create immersive content. To that end, for example, based on the pose 554 of a viewer 560 (viewing position and orientation), the renderer can provide the viewer with a viewport 552 of the scene, that is, a field of view of the scene as can be viewed from the viewer's viewing perspective.

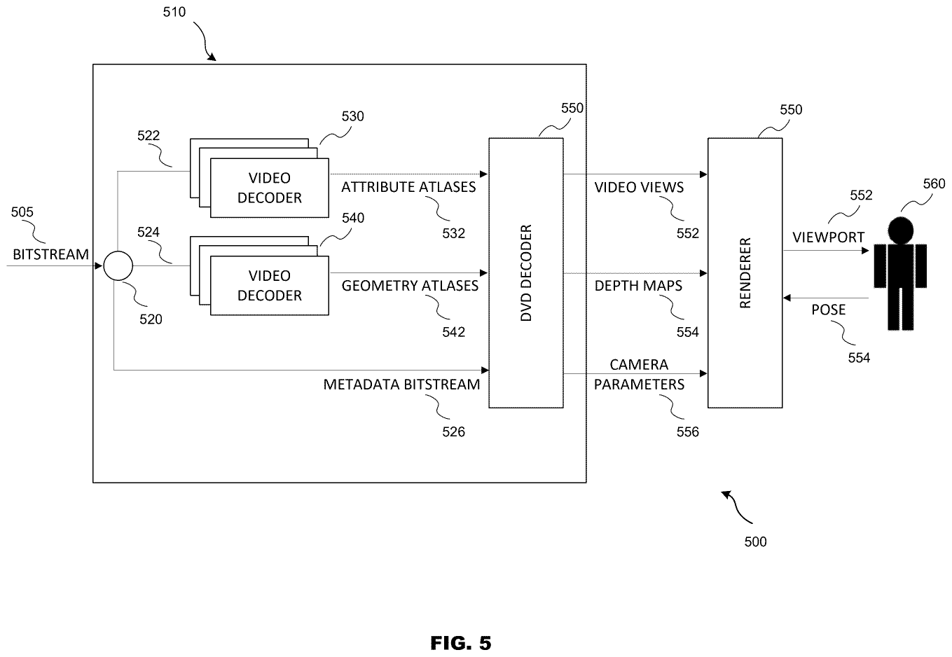

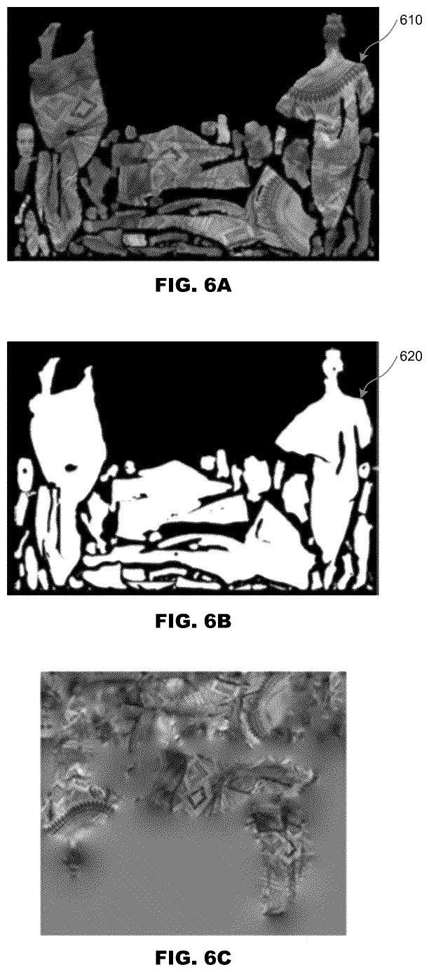

As described above, 2D video atlases—that is, attribute atlases 442 and geometry atlases 444—are compressed using legacy 2D video codecs that may be implemented according to standards such as AVC, HEVC, VVC, or other video formats such as AV1. The 2D video atlases are made of attribute (e.g., texture) patches and geometry patches that are assembled (or packed) into 2D pictures. FIGS. 6A-C illustrate atlases containing texture and occupancy patches that were derived from a point cloud.

FIGS. 6A-C illustrate a texture atlas 6A, a corresponding occupancy atlas 6B, and a filled-in texture atlas 6C. The texture atlas 6A and the corresponding occupancy atlas 6B were derived from 3D PCC content “Long Dress.” In FIG. 6A and FIG. 6B, each texture patch (e.g., 610) and its respective occupancy patch (e.g., 620) correspond to one view of the point cloud that can be generated by projecting the point cloud onto one image plane (that is, a projection image of a virtual camera). Generally, to produce an atlas from content captured from multiple views, a pruning operation and a packing operation may be performed by the DVD encoder 440. In a pruning operation, inter-view redundancy is removed, where objects that are captured in more than one view are retained in one view and removed (“pruned”) from the other views. In a packing operation, the pruned views are segmented and packed to form a compact representation, as shown in the atlases of FIG. 6A and FIG. 6B. Spatial transformation (e.g., translation and/or rotation) that are used by the DVD encoder 440 in the packing of each patch are stored in the metadata bitstream 446 to allow for the extraction (the unpacking) of the packed patches by the DVD decoder 550. The atlases may be further processed to increase the compression efficiency of the video encoders 450, 460. To that end, for example, the regions between patches are often padded to attenuate strong transitions among patches and to avoid high frequencies that are in general more coding costly, as demonstrated in FIG. 6C.

Generally, improving the 2D compression 450, 460 of the atlases 442, 444 can be done by facilitating the intra coding of patches within an atlas (e.g., by increasing the spatial correlation) and by facilitating the inter coding of patches across successive atlases (e.g., by increasing the temporal correlation). The present disclosure proposes additional means to improve the coding efficiency of patches within atlases when using 2D video encoders, as further discussed below.

Various coding structures are used in the coding of 2D video. For example, coding structures that are used when coding according to the VVC standard (or standards such as AVC or HEVC, as well as the AV1 format) include: a coded video sequence (CVS), a layer, a picture, a coding tree unit (CTU), a coding unit (CU), a prediction unit (PU), and a transform unit (TU). Accordingly, a video sequence is composed of pictures, associated with respective video frames, that may include several channels—such as a luminance channel (e.g., Y) and chrominance channels (e.g., U and V), in accordance with a used color model. A CVS may contain one or more layers each of which provides a different representation of the video content. For example, a picture of a video frame at a time t (or a video frame of a value p of picture order count (POC)) can be encoded into several layers, such as a base layer that contains a low-resolution representation of the picture and one or more enhancement layers that each adds additional detail to the low-resolution representation of the picture. Thus, each layer can provide a representation of the video content at a different resolution, quality level, or perspective. A layer may also provide a supplementary representation such as a depth map or a transparency map. A coded layer video sequence (CLVS) is a layer-wise CVS that contains coded data of a sequence of pictures across one layer.

In block-based video coding (e.g., the video coding described in reference to FIG. 2) a picture is partitioned into basic processing units, each of which includes a luma block and (optionally) respective chroma blocks. The size of the basic processing units may be up to 128×128 (in the VCC standard), up to 64×64 (in the HEVC standard), or 16×16 (in the AVC and previous standards where such units are referred to as macroblocks). For example, a basic processing unit of size 64×64 typically includes a 64×64 luma block and respective two 32×32 chroma blocks. Further partitioning of a basic processing unit of the picture is represented by a respective tree syntax, that is, a CTU structure that was introduced into the HEVC and VCC standards. The leaves of a CTU's tree can be associated with coding units (CU) of various sizes (e.g., 8×8, 16×16, or 32×32 blocks) that partition the respective basic processing unit. A CU (including a luma block and respective chroma blocks) is the coding entity for which a prediction mode is selected by the encoder—an intra prediction mode or an inter prediction mode (i.e., a motion compensated prediction mode). If a CU is encoded in an inter prediction mode, subsequent splitting of the CU may be carried out to form prediction units (PU), where pixels of the luma block and chroma blocks of a PU share the same set of motion parameters. A CU of a CTU may be further split into transform units (TU), where the same transform is applied for coding residual data (that is, the difference between a prediction block and a respective original block to be encoded) of the luma block and chroma blocks of the TU.

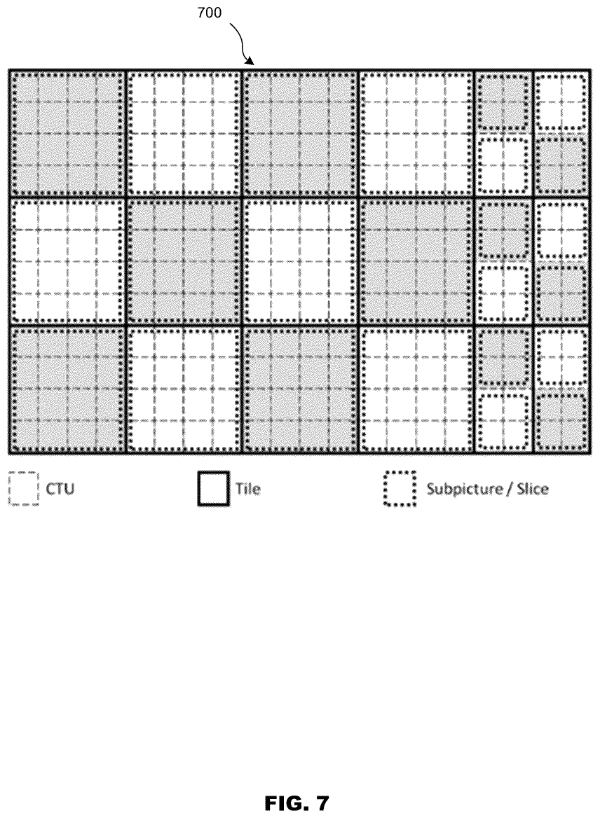

In addition, a picture can be segmented into tiles, slices, and subpictures (where subpictures were introduced in the VVC standard), each of these segments contains a number of complete CTUs. FIG. 7 illustrates an example segmentation of a picture 700. As shown, picture 700 is segmented into 18 tiles, 24 slices and 24 subpictures. Generally, tiles cover rectangular regions of the picture, confined within horizontal and vertical boundaries that split the picture into columns and rows of tiles, each of which containing CTUs. Slices of a picture may be determined according to two modes: rectangular slices and raster-scan slices. A rectangular slice covers a rectangular region of the picture, typically, containing one or more complete tiles or one or more complete CTU rows within a tile. A raster-scan slice may contain one or more complete tiles in a tile raster scan order, and, thus, is not necessarily of a rectangular shape. A subpicture contains one or more rectangular slices that cover a rectangular region of the picture. Note that in the example of FIG. 7 each subpicture contains one slice. A subpicture may be extractable (that is, independently encodable and decodable) or non-extractable. In each of these cases, cross-boundaries filtering may be set on or off for each subpicture by the encoder. For example, in the VVC standard, motion vectors of coding blocks in a subpicture can point outside of the subpicture even when the subpicture is extractable. Importantly, for subpictures, either or both of the following conditions need to be satisfied: 1) all CTUs of a subpicture must be part of the same tile or 2) all CTUs in a tile must be part of the same subpicture. The layout of subpictures is typically signaled in the sequence parameter sets (SPS), thus, signaling the same layout within a CLVS, as described in the example of Table 1 according to the VVC standard.

TABLE 1
SPS signaling of subpicture layout.

| | Descriptor |
|---|---|
| seq_parameter_set_rbsp( ) { | |
| ... | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && | |
| i <= sps num_subpics_minus1; i++ ) { | |
| if( !sps_subpic_same_size_flag \| \| i = = 0 ) { | |
| if( i > 0 && sps_pic_width_max_in_luma_samples > CtbSizeY ) | |
| sps_subpic_ctu_top_left_x[ i ] | u(v) |
| if( i > 0 && sps_pic_height_max_in_luma_samples > CtbSizeY ) | |
| sps_subpic_ctu_top_left_y[ i ] | u(v) |
| if( i < sps_num_subpics_minus1 && | |
| sps_pic_width_max_in_luma_samples > CtbSizeY ) | |
| sps_subpic_width minus1[ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping_present_flag ) | |
| for( i = 0; i <= sps_num_subpics_minus1; i++ ) | |
| sps_subpic_id[ i ] | u(v) |
| } | |
| } | |
| ... | ue(v) |
| } | |

Subpictures are useful, for example, for extracting viewports from omnidirectional or immersive video, for scalable rendering of content from a single bitstream, for parallel encoding, and for reducing the number of streams and respective decoder instances (thereby, simplifying the synchronization task when decoding and rendering data from different streams).

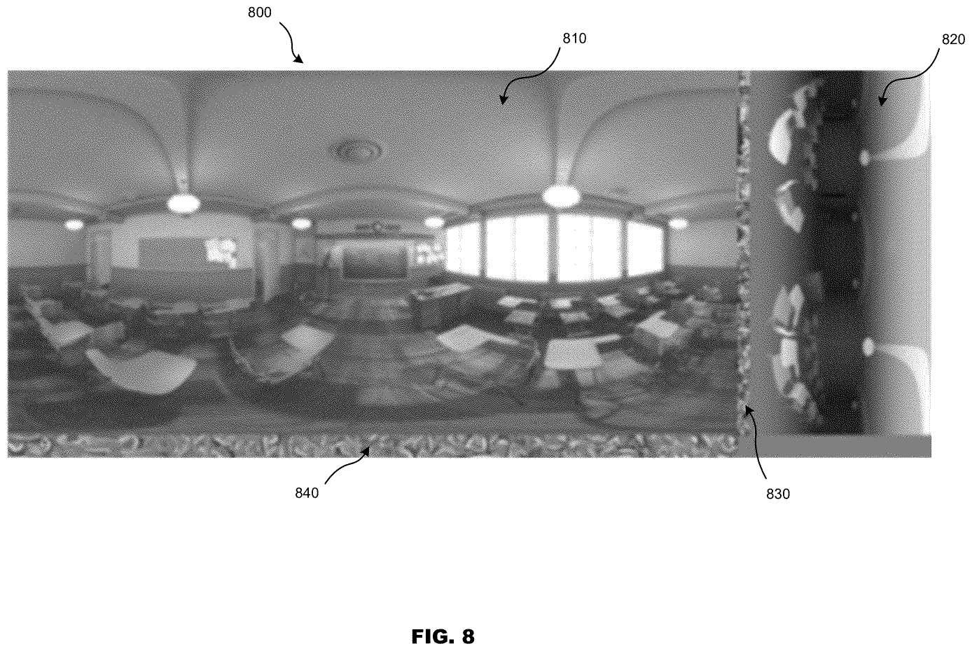

Using subpictures for coding atlases is described in Santamaria et al., Coding of Volumetric Content with MIV Using VVC subpictures, MMSP 2021 (“Santamaria”). Santamaria provides an example, as described herein in reference to FIG. 8. FIG. 8 illustrates an atlas 800, including texture and geometry data. The atlas 800 is created such that one subpicture 810 of the atlas represents texture data, that is, a full equirectangular projection (ERP) of the video content; and the remaining subpictures 820-840 of the atlas represent geometry data, that is, a depth map 820 and patches 830, 840 that may be used to enable six degrees of freedom viewing. In another example, the geometry data and the texture data may be packed separately into a geometry atlas and a texture atlas, respectively, and may be encoded independently.

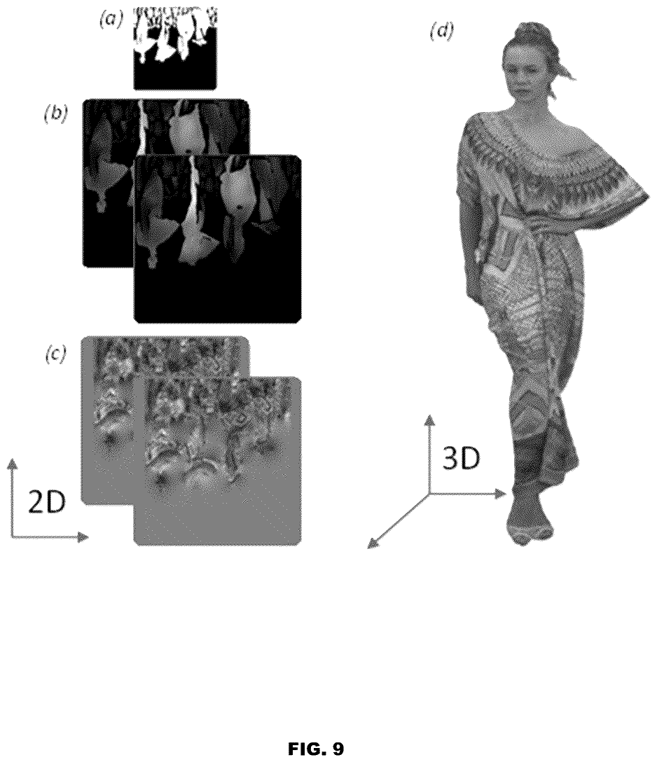

Similarly, multiple 2D video streams can be used to encode occupancy atlas(es), geometry atlas(es), and texture atlas(es) that represent a point cloud. To allow for a denser point cloud, multiple 3D point layers per frames may be created, resulting in a large number of maps. In the V-PCC standard, a point cloud may be represented by occupancy, geometry, and texture maps. FIG. 9 illustrates a point cloud representation, including occupancy, geometry, and texture atlases. In the example of FIG. 9, the point cloud is described by (a) a frame containing an occupancy atlas, (b) two frames containing respective geometry (depth) atlases, and (c) two frames containing respective texture atlases. Also shown is (d) the reconstructed point cloud. In this case, five video streams are used—that is, 2·N+1 videos streams, where Nis the number of frames used for the geometry atlases and the number of frames used for the texture atlases. Note that in this case, the frame rate used by the streams of geometry atlases and the texture atlases is twice the frame rate of the occupancy atlas stream.

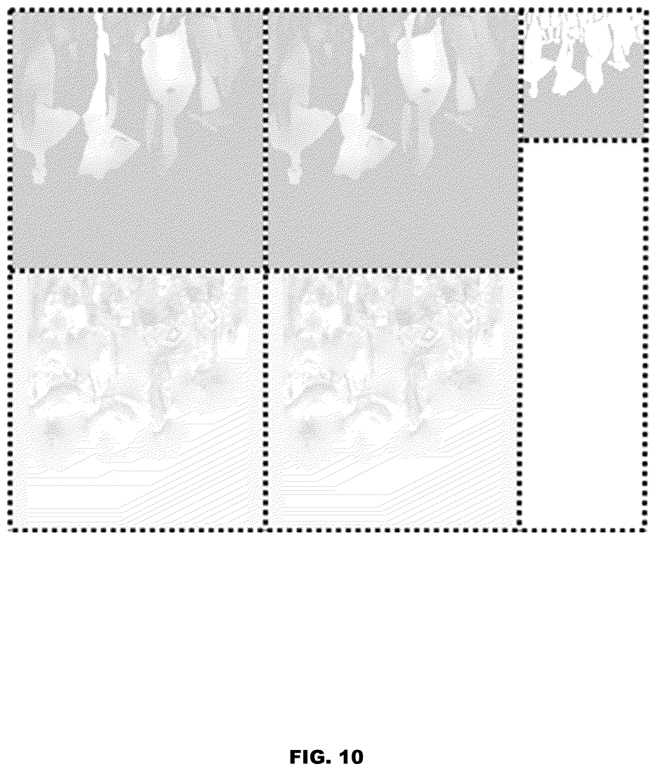

Hence, in the example of FIG. 9, the geometry, texture, and occupancy atlases are coded in separate video streams. However, a frame packing mode is defined in the V3C standard for MIV (i.e., its syntax structure is signaled in the vps_extention parameter) and may further be used to store V-PCC atlases in one video stream, avoiding the need to align decoded data from multiple streams (the output of multiple decoders). FIG. 10 illustrates the packing of the geometry, texture, and occupancy atlases into respective subpictures of a video picture. Hence, when using the frame packing mode of the V3C standard, 2·N+1 video streams are packed into one video stream.

Containing atlases in subpicture structures, as described above, limits the efficiency in which these atlases can be encoded by 2D video encoders that follow, for example, the VVC standard. This is because: 1) the lack of flexibility of the currently defined subpictures leads to inefficient compression of patches; 2) the layout of subpictures is fixed for the entire sequence; and 3) subpictures, defined within rectangular pictures, are not allowed to change their size dynamically.

Aspects disclosed herein provide for an enhanced subpicture structure, namely, a dynamic subpicture, that overcomes the above-mentioned limitations. As disclosed herein, features of a dynamic subpicture include: 1) a dynamic size (or resolution) change of a subpicture, at the subpicture level, using reference picture resampling (RPR) support; 2) a subpicture layout of a one-dimensional vector of subpictures, namely, 1D layout, so that a subpicture needs not be constrained to reside inside a picture structure; and 3) inter subpicture prediction, using (spatial or temporal) inter subpictures referencing. The dynamic subpictures disclosed herein are also referred to hereinafter as subpictures.

### Support for an Adaptive Subpicture Size.

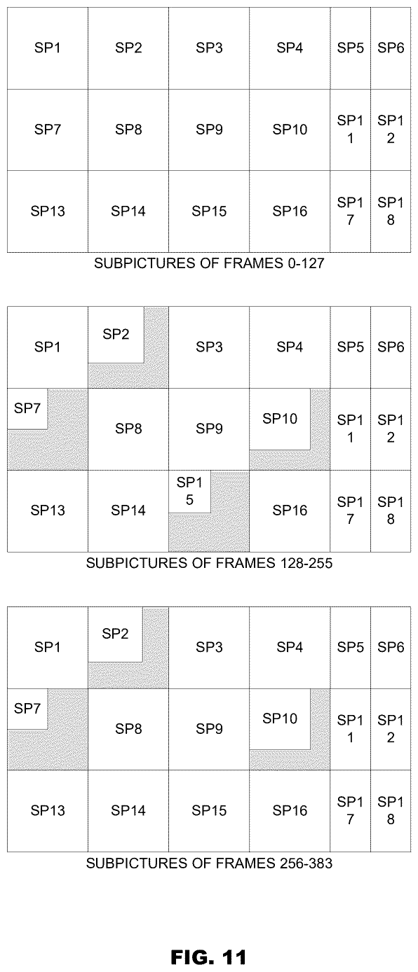

In an aspect, the size (or resolution) of a subpicture can be changed dynamically at the subpicture level. This contrasts with the manner it is defined in the VVC standard, where the layout of subpictures, typically signaled in the SPS, is constrained to be constant within a CLVS. To support a dynamically changing subpicture size, the RPR functionality can be applied at the subpicture level. FIG. 11 illustrates subpictures, some of which have their size changed within a sequence of frames 0-383. In the example of FIG. 11, the resolution of some of the subpictures dynamically changes every 128 frames. For example, subpicture SP2 is initially at a full resolution, then its resolution changes to ⅔ of the full resolution starting at frame 128. Note that RPR is required to predict this subpicture from frame 128 and forward when referencing subpictures from frames that precede frame 128. Likewise, subpicture SP15 that is initially at a full resolution, its resolution changes to ½ of the full resolution staring at frame 128, then it is back to full resolution from frame 256 and forward.

To enable this feature, new syntax elements are required to dynamically indicate the size variation per subpicture. In the example of Table 2, a first flag is added (sps_subpic_dynamic_size_flag) to signal whether the subpictures' size can dynamically change or not. When this flag is set to 1, for each subpicture of index i (also noted for notation simplification, subpicture i), the width and height ratios are signaled (sps_subpic_width_ratio[i] and sps_subpic_height_ratio[i]). In this example, these syntax elements are inserted into the SPS. Therefore, a picture whose associated subpictures change in resolution (size) needs to be preceded by an SPS with the above syntax elements inserted. In the example of FIG. 11, three SPSs should be set with the above syntax elements since the resolution of some subpictures changes three times. In an aspect, when sps_subpic_dynamic_size_flag is not present, it can be inferred to be equal to 0, indicating that the dynamic subpicture size feature is disabled.

TABLE 2
modified SPS signaling of dynamic subpicture size.

| | Descriptor |
|---|---|
| seq_parameter_set_rbsp( ) { | |
| ... | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| if( !sps_subpic_same_size_flag ) | |
| sps_subpic_dynamic_size_flag | u(1) |
| } | |
| for( i = 0; sps_num_subpics_minus1 > 0 && | |
| i <= sps_num_subpics_minus1; i++ ) { | |
| if( !sps_subpic_same_size_flag \| \| i = = 0 ) { | |
| if( i > 0 && sps_pic_width_max_in_luma_samples > CtbSizeY ) | |
| sps_subpic_ctu_top_left_x[ i ] | u(v) |
| if( i > 0 && sps_pic_height_max_in_luma_samples > CtbSizeY ) | |
| sps_subpic_ctu_top_left_y[ i ] | u(v) |
| if( i < sps_num_subpics_minus1 && | |
| sps_pic_width_max_in_luma_samples > CtbSizeY ) | |
| sps_subpic_width_minus1[ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| if( sps_subpic_dynamic_size_flag ) { | |
| sps_subpic_width_ratio[ i ] | u(v) |
| sps_subpic_height_ratio[ i ] | u(v) |
| } | |
| } | |
| if( !sps_independent_subpics_flag ) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping present_flag ) | |
| for( i = 0; i <= sps_num_subpics_minus1; i++ ) | |
| sps_subpic_id[ i ] | u(v) |
| } | |
| } | |
| ... | ue(v) |
| } | |

In an aspect, the scaling ratio of each subpicture can be indicated in the picture parameter set (PPS), as shown in the example of Table 3. In this case, subpicture ratio control is provided at the picture level (instead of at the sequence level). In another aspect, the scaling ratio of each subpicture can be indicated in the picture header.

TABLE 3
PPS signaling of subpictures ratio

| | Descriptor |
|---|---|
| pic_parameter_set_rbsp( ) { | |
| pps_pic_parameter_set_id | u(6) |
| pps_seq_parameter_set_id | u(4) |
| pps_mixed_nalu_types_in_pic_flag | u(1) |
| pps_pic_width_in_luma_samples | ue(v) |
| pps_pic_height_in_luma_samples | ue(v) |
| pps_conformance_window_flag | u(1) |
| if( pps_conformance_window_flag ) { | |
| pps_conf_win_left_offset | ue(v) |
| pps_conf_win_right_offset | ue(v) |
| pps_conf_win_top_offset | ue(v) |
| pps_conf_win_bottom offset | ue(v) |
| } | |
| pps_scaling_window_explicit_signalling_flag | u(1) |
| if( pps_scaling_window_explicit_signalling_flag ) { | |
| pps_scaling_win_left_offset | se(v) |
| pps_scaling_win_right_offset | se(v) |
| pps_scaling_win_top_offset | se(v) |
| pps_scaling_win_bottom_offset | se(v) |
| } | |
| if( sps_subpic_dynamic_size_flag ) { | |
| for( i = 0; sps_num_subpics_minus1 > 0 && i <= | |
| sps_num_subpics_minus1; i++ ) { | |
| if( !sps_subpic_same_size_flag \| \| i = = 0 ) { | |
| sps_subpic_width_ratio[ i ] | u(v) |
| sps_subpic_height_ratio[ i ] | u(v) |
| } | |
| } | |
| } | |
| ... | |

### Support for an Adaptive One-Dimensional Layout.

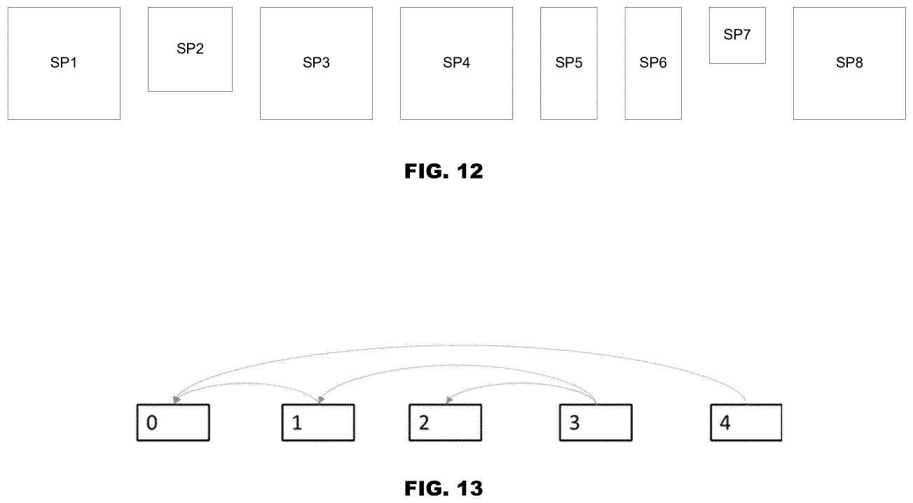

In an aspect, the subpictures associated with a video frame can be organized in a list of subpictures, namely, a one-dimensional (1D) layout. That is, instead of placing the subpictures within a picture structure of a video frame (as illustrated in FIG. 11), the subpictures are placed in a list, containing subpictures of variable sizes (resolutions). FIG. 12 illustrates a 1D layout of subpictures SP1-SP8 associated with a video frame. Thus, in one aspect, subpictures may be arranged within a picture structure, defined by their position within the picture and their size, while, in another aspect, subpictures may be arranged in a 1D layout, defined only by their size. Advantageously, patches can be distributed to different subpictures of different resolutions (such as the subpictures of FIG. 11 or FIG. 12) based on the patches' content or based on application-based priorities. For example, patches that contain homogeneous, continuous or similar texture may be packed into one subpicture to maintain spatial cross-patch continuities.

To enable the 1D layout feature, a new syntax element is introduced, defined herein by a flag: sps_subpic_1D_layout. When this flag is set to 1, the signaling of the position of subpicture of index i inside a 2D picture (i.e., sps_subpic_ctu_top_left_x[i] and sps_subpic_ctu_top_left_y[i]) is not required. Only the subpictures' dimensions are signaled. The signaling of sps_subpic_info_present_flag must be moved before indicating picture size; picture size is signaled when sps_subpic_1D_layout is set to 0. These changes are shown in the example of

Table 4 (moved syntax is indicated in italic and strikethrough font). In an aspect, when sps_subpic_1D_layout is not present, it is inferred to be equal to 0, indicating that the adaptive subpicture layout feature is disabled.

TABLE 4
modified SPS signaling of 1D layout of subpictures.

| | Descriptor |
|---|---|
| seq_parameter_set_rbsp( ) { | |
| sps_seq_parameter_set_id | u(4) |
| sps_video_parameter_set_id | u(4) |
| sps_max_sublayers_minus1 | u(3) |
| sps_chroma_format_idc | u(2) |
| sps_log2_ctu_size_minus5 | u(2) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| sps_gdr_enabled_flag | u(1) |
| sps_ref_pic_resampling_enabled_flag | u(1) |
| if( sps_ref_pic_resampling_enabled_flag ) | |
| sps_res_change_in_clvs_allowed_flag | u(1) |
| sps_subpic_info_present_flag | u(1) |
| if( sps_subpic_info present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| sps_subpic_1D_layout | u(1) |
| } | |
| } | |
| if( ! sps_subpic_ID_layout ) { | |
| sps_pic_width_max_in_luma_samples | ue(v) |
| sps_pic_height_max_in_luma_samples | ue(v) |
| } | |
| sps_conformance_window_flag | u(1) |
| if( sps_conformance_window_flag ) { | |
| if( ! sps_subpic_ID_layout ) { | |
| sps_conf_win_left_offset | ue(v) |
| sps_conf_win_right_offset | ue(v) |
| sps_conf_win_top_offset | ue(v) |
| sps_conf_win_bottom_offset | ue(v) |
| } | |
| } | |
| [symbol] | [symbol] |
| if( sps_subpic_info_present_flag ) { | |
| [symbol] | [symbol] |
| [symbol] | |
| [symbol] | [symbol] |
| [symbol] | [symbol] |
| [symbol] | |
| for( i = 0; sps_num_subpics_minus1 > 0 && i <= | |
| sps_num_subpics_minus1; i++ ) { | |
| if( !sps_subpic_same_size_flag \| \| i = = 0){ | |
| if( ! sps_subpic_ID_layout ) { | |
| if(i > 0 && sps_pic_width_max_in_luma_samples > CtbSizeY ) | |
| sps_subpic_ctu_top_left_x[ i ] | u(v) |
| if(i> 0 && sps_pic_height_max_in_luma_samples > CtbSizeY ) | |
| sps_subpic_ctu_top_left_y[ i ] | u(v) |
| } | |
| if( i < sps_num_subpics_minus1 && | |
| sps_pic_width_max_in_luma_samples > CtbSizeY ) | |
| sps_subpic_width_minus1 [ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping_present_flag ) | |
| for(i= 0; i <= sps_num_subpics_minus1; i++) | |
| sps_subpic_id[ i ] | u(v) |
| } | |
| } | |
| ... | |
| } | |

Note that the resolution of the subpictures in the 1D layout, typically signaled in the SPS, is not constrained to be constant within a CLVS. Note that signaling relative to picture size, when the 1D layout is used, is not required in other structures such as PPS. The change in the PPS is shown in the example of Table 5.

TABLE 5
modified PPS signaling of subpicture 1D layout.

| | Descriptor |
|---|---|
| pic_parameter_set_rbsp( ) { | |
| pps_pic_parameter_set_id | u(6) |
| pps_seq_parameter_set_id | u(4) |
| pps_mixed_nalu_types_in_pic_flag | u(1) |
| if( ! sps_subpic_ID_layout) { | |
| pps_pic_width_in_luma_samples | ue(v) |
| pps_pic_height_in_luma_samples | ue(v) |
| } | |
| pps_conformance_window_flag | u(1) |
| if( pps_conformance_window_flag ) { | |
| if( ! sps_subpic_1D_layout) { | |
| pps_conf_win_left_offset | ue(v) |
| pps_conf_win_right_offset | ue(v) |
| pps_conf_win_top_offset | ue(v) |
| pps_conf_win_bottom_offset | ue(v) |
| } | |
| } | |
| pps_scaling_window_explicit_signalling_flag | u(1) |
| if( pps_scaling_window_explicit_signalling_flag ) { | |
| if( ! sps_subpic_ID_layout ) { | |
| pps_scaling_win_left_offset | se(v) |
| pps_scaling_win_right_offset | se(v) |
| pps_scaling_win_top_offset | se(v) |
| pps_scaling_win_bottom_offset | se(v) |
| } | |
| } | |
| pps_output_flag_present_flag | u(1) |
| ... | |

Support for Referencing Subpictures within the Same Picture or the Same 1D Layout.

In an aspect, content of a subpicture can be predicted using content from another subpicture that is contained within the same picture or within the same 1D layout. The prediction, namely, intra subpicture prediction, may be coded or inferred (for instance, by template matching) and may be based on a reference subpicture contained in the same picture or in the same 1D layout to which the current subpicture belongs.

To enable this feature, the reference subpictures for a given subpicture (all belonging to the same picture or 1D layout) need to be known. A signaling mechanism is introduced herein to indicate for each subpicture which subpictures are used as reference for prediction. Table 6 provides an example syntax for subpicture referencing. A new syntax element sps_max_num_reference_subpics is added. When this syntax element is equal to 0, it means that the prediction from another subpicture is not enabled. When it is greater than 0, the prediction from another subpicture is enabled. In this case, for each subpicture of index i, the index of the reference subpicture sps_ref_subpic_id[i][j] is indicated for j=0 to j=(sps_max_num_reference_subpics−1).

TABLE 6
SPS signaling of reference subpictures.

| | Descriptor |
|---|---|
| seq_parameter_set_rbsp( ) { | |
| ... | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && | |
| i <= sps_num_subpics_minus1; i++ ) { | |
| if( !sps_subpic_same_size_flag \| \| i = = 0 ) { | |
| if( i > 0 && sps_pic_width_max_in_luma_samples > CtbSizeY ) | |
| sps_subpic_ctu_top_left_x[ i ] | u(v) |
| if( i > 0 && sps_pic_height_max_in_luma_samples > CtbSize Y ) | |
| sps_subpic_ctu_top_left_y[ i ] | u(v) |
| if(i < sps_num_subpics_minus1 && | |
| sps_pic_width_max_in_luma_samples > CtbSizeY ) | |
| sps_subpic_width_minus1[ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| } | |
| if( !sps_independent_subpics_flag ) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping present_flag ) | |
| for( i = 0; i <= sps_num_subpics_minus1; i++ ) | |
| sps_subpic_id[ i ] | u(v) |
| } | |
| sps_max_num_reference_subpics | ue(v) |
| if( sps_max_num_reference_subpics > 0 ) { | |
| for( i = 0; sps_num_subpics_minus1 > 0 && i <= | |
| sps_num_subpics_minus1; i++ ) { | |
| for( j = 0; j < sps_max_num_reference_subpics; j++ ) { | |
| sps_ref_subpic_id[ i ][ j ] | u(v) |
| } | |
| } | |
| } | |
| ... | ue(v) |
| } | |

In an aspect, a value larger than the maximum sps_subpic_id for the variable sps_ref_subpic_id[i][j] means that there is no reference subpic_id for the j^{th} element. In another aspect, the number of reference subpictures is indicated for each subpicture. An example of a syntax for signaling the number of reference subpictures is provided in Table 7, showing a new syntax element sps_num_reference_subpics[i] that indicates the number of reference subpictures used by subpicture of index i. The value of sps_num_reference_subpics[i] is in the range of 0 to (sps_max_num_reference_subpics−1).

TABLE 7
SPS signaling of a number of reference subpictures.

| | |
|---|---|
| sps_max_num_reference_subpics | ue(v) |
| if( sps_max_num_reference_subpics > 0 ) { | |
| for( i = 0; sps_num_subpics_minus1 > 0 && i <= | |
| sps_num_subpics_minus1; i++ ) { | |
| sps_num_reference_subpics[ i ] | |
| for( j = 0; j < sps_num_reference_subpics[ i ]; j++ ) { | |
| sps_ref_subpic_id[ i ][ j ] | u(v) |
| } | |
| } | |

In an aspect, in sps_ref_subpic_id[i][j], the reference subpicture index j is constrained to be lower than index i of the current subpicture. This means that a subpicture refers to preceding (already decoded) subpictures. This enforces a decoding order, so that the subpictures are decoded in increasing id number.

FIG. 13 illustrates subpicture dependency. In reference to FIG. 13, using the syntax of Table 7, the following values are obtained:
sps_max_num_reference_subpics=2
for subpicture 0
   sps_num_reference_subpics[0]=0
for subpicture 1
   sps_num_reference_subpics[1]=1
   sps_ref_subpic_id[1][0]=0
for subpicture 2
   sps_num_reference_subpics[2]=0
for subpicture 3
   sps_num_reference_subpics[3]=2
   sps_ref_subpic_id[3][0]=1
   sps_ref_subpic_id[3][1]=2
for subpicture 4
   sps_num_reference_subpics[4]=1
   sps_ref_subpic_id[4][0]=0
      The above can also be written as a list “INTRA_REF_LIST” defined as follows:

### INTRA_REF_LIST:

sps_ref_subpic_id[0]={ }
sps_ref_subpic_id[1]={0}
sps_ref_subpic_id[2]={ }
sps_ref_subpic_id[3]={1, 2}
sps_ref_subpic_id[4]={0}

In another aspect, instead of indicating the indices of the reference subpictures (sps_ref_subpic_id[i][j]) used by the subpicture of index i, flags are signaled (sps_ref_subpic_flag[i][j]) for all the subpictures except the current one (that is, the subpictures of index j=0 to sps_num_subpics_minus1 where j≠i) to indicate whether the subpicture of index j is used or not as reference for the subpicture of index i, as shown in the example of Table 8.

TABLE 8
SPS signaling of reference subpictures using a flag.

| | |
|---|---|
| for( i = 0; sps_num_subpics_minus1 > 0 && i <= | |
| sps_num_subpics_minus1; i++ ) { | |
| for( j = 0; j < sps_num_subpics_minus1; j++ ) { | |
| if( j != i ) { | |
| sps_ref_subpic_flag[ i ][ j ] | u(1) |
| } | |

In yet another aspect, only preceding subpictures can be referred to by the current subpicture of index i, as shown in Table 9. Table 9 shows modifications made relative to the syntax in Table 8.

TABLE 9
SPS signaling of reference subpictures using a flag.

| | |
|---|---|
| [symbol] | |
| [symbol] | |
| for( i = 1; sps_num_subpics_minus1 > 0 && i <= | |
| sps_num_subpics_minus1; i++ ) { | |
| [symbol] | |
| for( j = 0; j < i; j++ ) { | |
| [symbol] | |
| sps_ref_subpic_flag[ i ][ j ] | u(v) |
| } | |

In an aspect, a subpicture is implicitly dependent on the N preceding subpictures (in signaling order), where N may be signaled in the SPS, specified in a profile, or specified by default (e.g., N is set to 6). In another aspect, the signaling is done in PPS instead of SPS, to have more flexibility to control the subpictures' references. In yet another aspect, the signaling is done in the adaptation parameter sets (APS) instead of SPS, to have even more flexibility than PPS to control the subpictures references.

Support for Referencing Subpictures from Preceding Pictures or Preceding 1D Layouts.

A subpicture can be predicted using another subpicture from another picture or another 1D layout as a reference. The prediction, namely, inter subpicture prediction, is similar to temporal prediction and may be based on motion compensation (where the motion data is either coded or inferred, for instance, by template matching) and using a reference subpicture from a picture or a 1D layout associated with a preceding (in decoding order) video frame.

As a default (and as currently defined in the VVC standard), a subpicture of index k in a current picture can use a reference subpicture of the same index k from a reference picture. This means that it is assumed that the content of a subpicture is more correlated to the content of temporally corresponding subpictures than the content of not temporally corresponding subpictures. Additionally, since all motion vectors (MVs) are computed relative to the current subpicture, the MVs that point outside the reference subpicture require padding with the pointed-to-content.

Similar to other standards, in VVC, referencing to pictures is facilitated by a reference picture list (RPL). There are two RPLs—RPL 0 (L0) and RPL 1 (L1)—that are directly signaled and derived.
Reference picture marking is directly based on L0 and L1, utilizing both active and inactive entries in the RPLs, while only active entries may be used as reference indices in inter prediction of CTUs.
Information required for the derivation of the two RPLs is signaled by syntax elements and syntax structures in the SPS, the PPS, the Picture header (PH), and the Slice header (SH). Predefined RPL structures are signaled in the SPS, for use by referencing in the PH or SH.
The two RPLs are generated for all types of slices: B, P, and I.
The two RPLs are constructed without using an RPL initialization process or an RPL modification process.

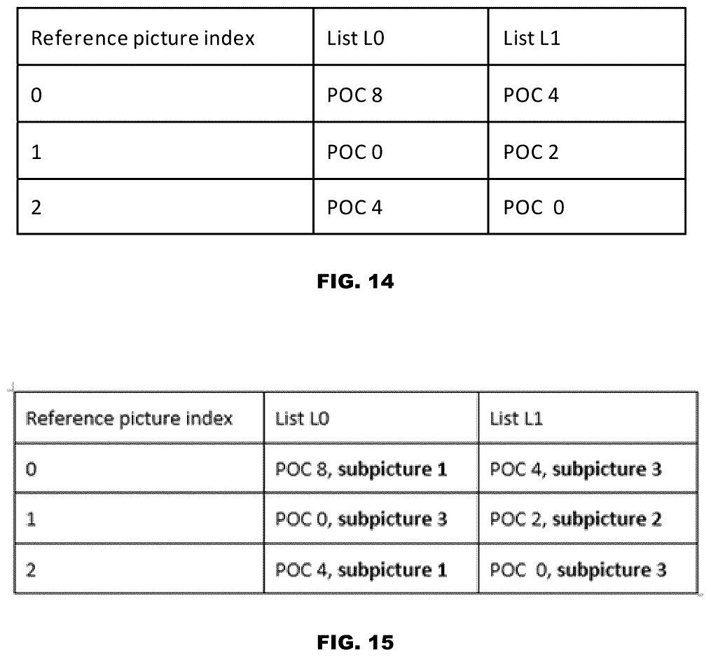

FIG. 14 illustrates reference picture lists. The reference picture lists are used by a traditional decoder, for example, when decoding the picture with POC 6. Each index in the list (L0 or L1) points to a reference picture in the Decoded Picture Buffer (DPB), corresponding to a POC of an already decoded picture in the sequence. In this example, the given picture with POC 6 can refer to pictures with POCs: 0, 2, 4, 8 from the lists.

In an aspect, the two reference picture lists, L0 and L1 of FIG. 14, are modified to enable referencing of subpictures. FIG. 15 illustrates reference subpicture lists. As shown, a given subpicture of a given picture can refer to subpicture 3 of picture with POC 0, subpicture 2 of picture with POC 2, subpictures 1 and 3 of picture with POC 4, or subpicture 1 of picture with POC 8. Thus, for each reference picture index, a POC and a subpicture index are used to reference the correct subpicture to use as a reference to decode the current subpicture in the current picture or layout.

In an aspect, the list of available subpictures to be used as reference for inter subpicture prediction (that is, for predicting a subpicture within a different picture or layout) can be the same as the list of subpictures to be used as a reference for intra subpicture prediction (that is, for predicting a subpicture within the same picture or layout). Thus, the same list of reference subpictures can be used for intra and inter subpicture predictions. In another aspect, the current subpicture id is implicitly added to the list of reference subpictures for inter subpicture prediction. For each element in RPL (L0 or L1) both the index of the picture in the DPB and the index of the reference subpicture(s) as indicated in sps_ref_subpic_id[i] (where i is the index of the current subpicture) are signaled or deduced from the signaled syntax elements. For example, in reference to FIG. 13, the sps_ref_subpic_id is populated as a list “INTER_REF_LIST” defined as follows:

### INTER_REF_LIST:

sps_ref_subpic_id[0]={0}
sps_ref_subpic_id[1]={1, 0}
sps_ref_subpic_id[2]={2}
sps_ref_subpic_id[3]={3, 1, 2}
sps_ref_subpic_id[4]={4, 0}
   It can be noticed that INTER_REF_LIST corresponds to INTRA_REF_LIST, where the reference list of each subpicture of index k (k=0 to 4) is completed by the index k.

As an example, in reference to FIG. 15, assuming a DPB is with the following reference pictures: DBP={0, 2, 4, 8} and a current subpicture is of index 3 (with the reference subpicture list sps_ref_subpic_id[3]={3, 1, 2}), then the picture/subpicture referencing table below is obtained:

| Reference | | |
|---|---|---|
| Picture | | |
| Index | L0 | L1 |
| 0 | Index_dpb = 3 (POC8), | Index dpb = 2 (POC4) |
| | index subpic = 1 (subpic1) | Index subpic = 0 (subpic3) |
| 1 | Index dpb = 0 (POC0) | Index dpb = 1 (POC2) |
| | Index subpic = 0 (subpic3) | Index subpic = 2 (subpic2) |
| 2 | Index dpb = 2 (POC4) | Index dpb = 0 (POC0) |
| | Index subpic = 1 (subpic1) | Index subpic = 0 (subpic3) |

In an aspect, the reference subpicture list can be extended. When applying inter subpicture prediction, a subpicture can access all the subpictures associated with previously decoded frames in the DPB. For this reason, the constraints of having a reference subpicture index smaller than the current subpicture index is no longer necessary for inter coded subpictures. In an aspect, the reference subpicture list is extended by symmetrizing the reference subpicture list already described. That means that when a subpicture of index i has a subpicture of index j in its subpicture reference list, then the reference subpicture of index i is automatically added in the reference subpicture list of the subpicture j. Using the same example as above, the reference subpicture lists for intra coded subpictures (corresponding to the example of FIG. 13) given as:

### INTRA_REF_LIST:

sps_ref_subpic_id[0]={ }
sps_ref_subpic_id[1]={0}
sps_ref_subpic_id[2]={ }
sps_ref_subpic_id[3]={1, 2}
sps_ref_subpic_id[4]={0}
   is transformed into the following lists for inter coded subpictures:
sps_ref_subpic_id[0]={0, 1, 4}
sps_ref_subpic_id[1]={1, 0, 3}
sps_ref_subpic_id[2]={2, 3}
sps_ref_subpic_id[3]={3, 1, 2}
sps_ref_subpic_id[4]={4, 0}
   That means that, for example, subpicture 1 of the current picture can refer to subpictures 1, 0, 3 of the reference picture (sps_ref_subpic_id[1]={1, 0, 3}).

In another aspect, the lists are not implicitly deduced for inter coded subpictures but are explicitly signaled using the same syntax as before without the constraint on the subpicture index, as shown in Table 10. The current subpicture index is derived implicitly as being the first reference subpicture index in the list, without having the need to transmit.

TABLE 10
SPS signaling of reference subpictures.

| | |
|---|---|
| sps_max_num inter reference subpics | ue(v) |
| if( sps_max_num_inter_reference_subpics > 0 ) { | |
| for( i = 0; sps num subpics minus1 > 0 && i <= | |
| sps_num_subpics_minus1; i++ ) { | |
| sps_num_inter reference subpics[ i ] | |
| for( j = 0; j < sps_num_inter_reference_subpics[ i ]; j++ ) { | |
| sps_inter_ref_subpic_id[ i ][ j ] | u(v) |
| } | |
| } | |

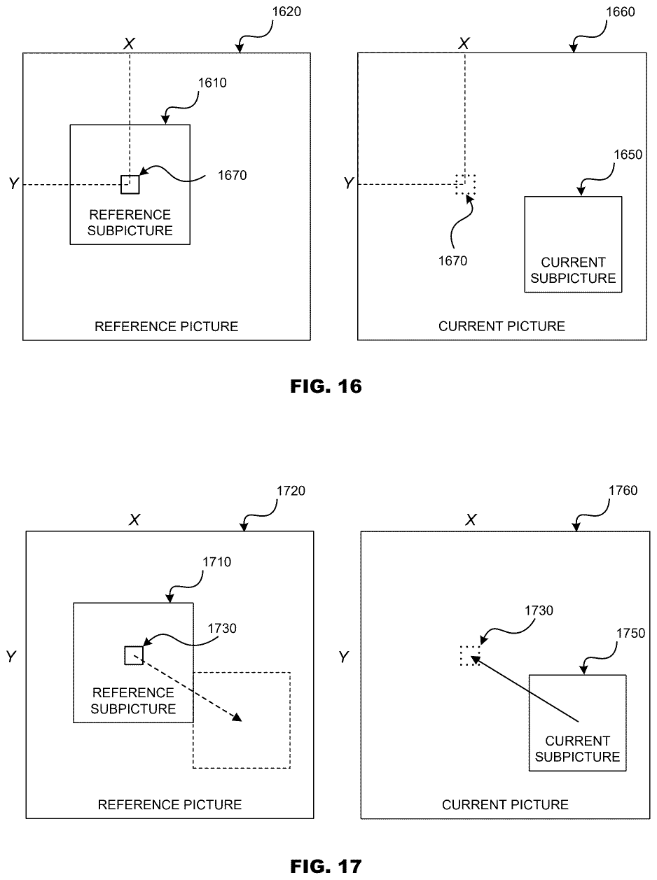

The motion vector used to reference a block in a different subpicture (of a different picture or layout) is typically relative to the top-left corner of the referenced subpicture, that is, pixel coordinate (0,0). FIG. 16 illustrates referencing to a block in a reference subpicture 1610 of a reference picture 1620 by a current subpicture 1650 of a current picture 1660. As shown in the example of FIG. 16, the same pixel coordinates system is used when accessing a motion compensated block 1670 from the reference subpicture.

In an aspect, when a reference subpicture list is transmitted, additional spatial information can be transmitted for respective indices in the list. For example, an offset (translation) value can be transmitted to denote the relative positions of a block from the current subpicture and a corresponding block (used for prediction) from the reference subpicture, as in the example of FIG. 17. FIG. 17 illustrates a relative referencing to a block in a reference subpicture 1710 of a reference picture 1720 by a current subpicture 1750 of a current picture 1760. As shown in the example of FIG. 17, an offset value is used to relate a motion compensated block 1730 from the reference subpicture 1710 to a block in the current subpicture 1750.

In an aspect, the spatial information (transmitted for respective indices in the reference subpicture list) can include geometric transformations. For example, geometric transformations that can be applied to a reference subpicture can include a translating operation (e.g., for relative referencing as explained in reference to FIG. 17), a mirroring operation along the x or y axis, or a rotating operation. In the latter, for example, the rotation angles may be limited to be in the set of {90, 180, 270} degrees, allowing geometric transformation only on the pixel coordinates. Examples for spatial information are shown in the table below:

| | Transformation Result | |
|---|---|---|
| Transformation | X-coordinat | Y-coordinat |
| translating—(dx, dy) | X + dx | Y + dy |
| mirroring—X | W − X | Y |
| mirroring—Y | X | H − Y |
| rotating—90 | H − Y | X |
| rotating—180 | W − X | H − Y |
| rotating—270 | Y | W − X |

where H and W are the height and the width of the reference subpicture. A syntax using all the spatial transformations is shown in the example of Table 11.

TABLE 11
Syntax for signaling spatial transformations.

| | |
|---|---|
| sps_max_num reference_subpics | ue(v) |
| if( sps_max_num_reference_subpics > 0 ) { | |
| for( i = 0; sps_num_subpics_minus1 > 0 && | |
| i <= sps_num_subpics_minus1; i++ ) { | |
| for( j = 0; j < sps_max_num_reference_subpics; j++ ) { | |
| sps_ref_subpic_id[ i ][ j ] | u(v) |
| sps_ref_subpic_transfo_mirrorX[ i ][ j ] | u(1) |
| sps_ref_subpic transfo mirrorY[ i ][ j ] | u(1) |
| sps_ref_subpic_transfo_rotate[ i ][ j ] | u(v) |
| sps_ref_subpic_transfo_offsetX[ i ][ j ] | s(v) |
| sps_ref_subpic_transfo_offsetY[ i ][ j ] | s(v) |
| } | |
| } | |
| } | |

Note that the possible values of variable sps_ref_subpic_transfo_rotate can be set to {0, 1, 2}, encoding respectively, rotations of {90, 180, 270} degrees. The order in which the geometric transformation is applied is fixed and is the same at the encoder and the decoder, for example: Rotation, mirror, mirror, and translation.

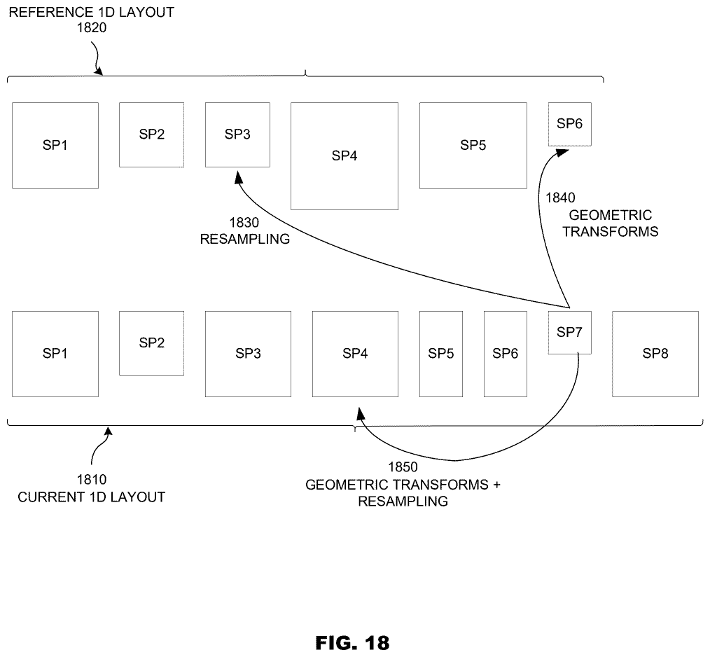

FIG. 18 illustrates inter and intra referencing by a subpicture. FIG. 18 shows subpictures SP1-SP8 of a current 1D layout of subpictures 1810 and subpictures SP1-SP6 of a reference 1D layout of subpictures 1820. As illustrated, a subpicture SP7, belonging to the current 1D layout 1810, refers to a subpicture SP4 from the same 1D layout 1810 (that is, intra subpicture referencing) and also refers to subpictures SP3 and SP6, belonging to a reference 1D layout 1820 (that is, inter subpicture referencing). Since SP7 refers to SP4, resampling may be required for the prediction process if SP4 is of different image resolution than SP7. Also, the prediction process may require additional spatial transformations (e.g., mirroring or rotating). For temporal prediction, SP7 refers to SP3 and SP6 from the reference 1D layout 1820. As illustrated, prediction based on SP6 may require spatial transformation, but not resampling when SP6 is of the same image resolution as SP7. Prediction based on SP3 may require resampling when SP3 and SP7 are not of the same image resolution.

For the case illustrated by FIG. 18, the values of different syntax elements mentioned above could be set as follows:

### INTRA_REF_LIST for SP7 to SP4

sps_ref_subpic_id[7][0]=4
sps_ref_subpic_transfo_mirrorX[7][0]=1
sps_ref_subpic_transfo_mirrorY[7][0]=0
sps_ref_subpic_transfo_rotation[7][0]=0.

### INTER_REF_LIST for SP7 to SP3

sps_ref_subpic_id[7][0]=3
sps_ref_subpic_transfo_mirrorX[7][0]=0
sps_ref_subpic_transfo_mirrorY[7][0]=0
sps_ref_subpic_transfo_rotation[7][0]=0

### INTER_REF_LIST for SP7 to SP6

sps_ref_subpic_id[7][1]=6
sps_ref_subpic_transfo_mirrorX[7][1]=0
sps_ref_subpic_transfo_mirrorY[7][0]=0
sps_ref_subpic_transfo_rotation[7][1]=1

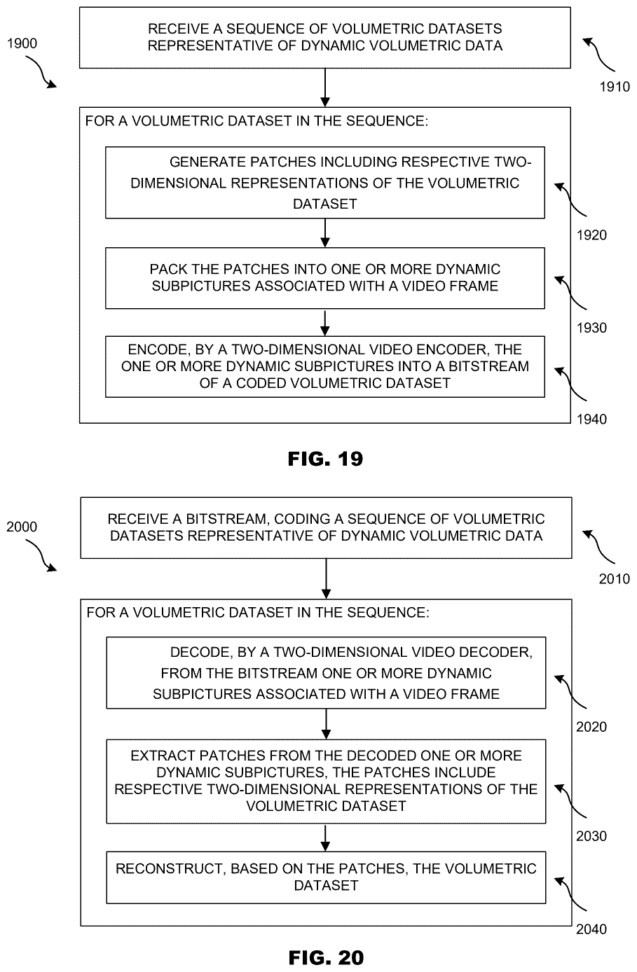

FIG. 19 is a flowchart of an example method 1900 for encoding dynamic volumetric data. The method 1900 begins, in step 1910, with receiving a sequence of volumetric datasets representative of dynamic volumetric data to be encoded. A volumetric dataset may comprise image view(s), corresponding depth map(s), and metadata including projection parameters of the respective image view(s). For a volumetric dataset in the sequence, the encoding may be carried out by steps 1920, 1930, 1940 of method 1900. In step 1920, patches may be generated. The patches include respective two-dimensional representations of the volumetric dataset—for example, a patch may contain geometry data or attribute data derived from the volumetric dataset. In step 1930, the generated patches may be packed into one or more dynamic subpictures associated with a video frame—for example, the packing may be based on the content of the patches, where patches that contain similar content are packed into the same subpicture. Then, in step 1940, the one or more dynamic subpictures are encoded, by a two-dimensional video encoder, into a bitstream of a coded video data.

FIG. 20 is a flowchart of an example method 2000 for decoding dynamic volumetric data. The method 2000 begins, in step 2010, with receiving a bitstream, coding a sequence of volumetric datasets representative of the dynamic volumetric data. For a volumetric dataset in the sequence, the decoding may be carried out by steps 2020, 2030, and 2040 of method 2000. In step 2020, from the bitstream, one or more dynamic subpictures associated with a video frame may be decoded by a two-dimensional video decoder. In step 2030, patches are extracted from the decoded one or more dynamic subpictures, the patches include respective two-dimensional representations of the volumetric dataset. Then, in step 2040, the volumetric dataset may be reconstructed based on the patches.

We have described several aspects and embodiments in the present disclosure. These aspects and embodiments provide at least the following outputs and results, including all combinations, across different claim categories and types:
Encoding, into coded video data, syntax elements that can enable the decoder to decode the coded video data, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, or a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.
   Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to VVC or HEVC, and can be applied, for example, to other standards and recommendations, as well as extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream. Additionally, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including, for example, manners that are common in video standards such as putting the information into an SPS, a PPS, a NAL unit, a header (for example, a NAL unit header, or a slice header), or an SEI message. Other manners are also available, including, for example, manners common for system level or application level standards such as signaling the information into one or more of the following:
a. SDP (session description protocol), a format for describing multimedia communication sessions for the purposes of session announcement and session invitation, for example, as described in RFCs and used in conjunction with RTP (Real-time Transport Protocol) transmission.
b. DASH MPD (Media Presentation Description) Descriptors, for example, as used in DASH and transmitted over HTTP. A descriptor is associated with a Representation or collection of Representations to provide additional characteristics to the content Representation.
c. RTP header extensions, for example, as used during RTP streaming.
d. ISO Base Media File Format, for example, as used in OMAF and using boxes which are object-oriented building blocks defined by a unique type identifier and length (also known as ‘atoms’ in some specifications).
e. HLS (HTTP live Streaming) manifest transmitted over HTTP. A manifest can be associated, for example, with a version or collection of versions of content to provide the characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (PDAs), and other devices that facilitate communication of information between end-users.

Reference to “one/an aspect” or “one/an embodiment” or “one/an implementation,” as well as other variations thereof, means that a particular feature, structure, characteristic, and so forth described in connection with the aspect/embodiment/implementation is included in at least one embodiment. Thus, the appearances of the phrase “in one/an aspect” or “in one/an embodiment” or “in one/an implementation,” as well any other variations, appearing in various places throughout this application, are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization parameter for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual data, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method for encoding, comprising:
receiving a sequence of volumetric datasets representative of dynamic volumetric data; and
encoding the sequence, the encoding comprises, for a volumetric dataset in the sequence:
generating patches including respective two-dimensional representations of the volumetric dataset,
packing the patches into one or more dynamic subpictures associated with a video frame, and
encoding, by a two-dimensional video encoder, the one or more dynamic subpictures into a bitstream of coded video data.

2-7. (canceled)

8. The method according to claim 1, further comprising:
placing the one or more dynamic subpictures in a one-dimensional (1D) layout, wherein each of the subpictures is defined by its size.

9. The method according to claim 1, further comprising:
signaling, in the bitstream, the placing of the one or more dynamic subpictures in the 1D layout using syntax element sps_subpic_1D_layout.

10. The method according to claim 1, further comprising:
intra subpicture predicting, by the two-dimensional video encoder, content of a subpicture of the one or more dynamic subpictures from content of at least one reference subpicture of the one or more dynamic subpictures.

11. The method according to claim 10, further comprising:
signaling, in the bitstream, the reference subpicture using syntax elements sps_max_num_reference_subpics and sps_ref_subpic_id.

12. The method according to claim 10, further comprising:
signaling, in the bitstream, the reference subpicture using syntax element sps_num_reference_subpics.

13. The method according to claim 10, further comprising:
signaling, in the bitstream, the reference subpicture using syntax element sps_ref_subpic_flag.

14. The method according to claim 1, further comprising:
inter subpicture predicting, by the two-dimensional video encoder, content of a subpicture of the one or more dynamic subpictures from content of at least one reference subpicture of dynamic subpictures associated with at least one other video frame.

15. The method according to claim 14, further comprising:
signaling, in the bitstream, the reference subpicture using syntax elements sps_max_num_inter_reference_subpics and sps_inter_ref_subpic_id.

16. The method according to claim 1, further comprising:
signaling, in the bitstream, a reference subpicture list, including indexes to reference subpictures, used for prediction by the two-dimensional video encoder.

17. The method according to claim 16, further comprising:
extending the reference subpicture list, wherein the reference subpicture list is symmetrized.

18. The method according to claim 16, wherein the reference subpicture list further comprises spatial information specifying at least one of translating, mirroring, or rotating operations associated with a reference subpicture in the reference subpicture list.

19. A method for decoding, comprising:
receiving a bitstream of coded video data generated by an encoder, coding a sequence of volumetric datasets representative of dynamic volumetric data; and
decoding the sequence, the decoding comprises, for a volumetric dataset in the sequence:
decoding, by a two-dimensional video decoder, from the bitstream one or more dynamic subpictures associated with a video frame,
extracting patches from the decoded one or more dynamic subpictures, the patches include respective two-dimensional representations of the volumetric dataset, and reconstructing, based on the patches, the volumetric dataset.

20. (canceled)

21. The method according to claim 19, wherein the one or more dynamic subpictures are placed, by the encoder, in a one-dimensional (1D) layout, wherein each of the subpictures is defined by its size.

22. The method according to claim 19, further comprising:
intra subpicture predicting, by the two-dimensional video decoder, content of a subpicture of the one or more dynamic subpictures from content of at least one reference subpicture of the one or more dynamic subpictures.

23. The method according to claim 19, further comprising:
inter subpicture predicting, by the two-dimensional video decoder, content of a subpicture of the one or more dynamic subpictures from content of at least one reference subpicture of dynamic subpictures associated with at least one other video frame.

24. An apparatus for encoding, comprising:
at least one processor; and
memory storing instructions that, when executed by the at least one processor, cause the apparatus to:
receive a sequence of volumetric datasets representative of dynamic volumetric data, and
encode the sequence, the encoding comprises, for a volumetric dataset in the sequence:
generating patches including respective two-dimensional representations of the volumetric dataset,
packing the patches into one or more dynamic subpictures associated with a video frame, and
encoding, by a two-dimensional video encoder, the one or more dynamic subpictures into a bitstream of coded video data.

25. (canceled)

26. The apparatus according to claim 24, wherein the encoding of the one or more dynamic subpictures further comprises:
placing the one or more dynamic subpictures in a one-dimensional (1D) layout, wherein each of the subpictures is defined by its size.

27. The apparatus according to claim 24, wherein the encoding of the one or more dynamic subpictures further comprises:
intra subpicture predicting, by the two-dimensional video encoder, content of a subpicture of the one or more dynamic subpictures from content of at least one reference subpicture of the one or more dynamic subpictures.

28. The apparatus according to claim 24, wherein the encoding of the one or more dynamic subpictures further comprises:
inter subpicture predicting, by the two-dimensional video encoder, content of a subpicture of the one or more dynamic subpictures from content of at least one reference subpicture of dynamic subpictures associated with at least one other video frame.

29. An apparatus for decoding, comprising:
at least one processor; and
memory storing instructions that, when executed by the at least one processor, cause the apparatus to:
receive a bitstream of coded video data generated by an encoder, coding a sequence of volumetric datasets representative of dynamic volumetric data, and
decode the sequence, the decoding comprises, for a volumetric dataset in the sequence:
decode, by a two-dimensional video decoder, from the bitstream one or more dynamic subpictures associated with a video frame,
extract patches from the decoded one or more dynamic subpictures, the patches include respective two-dimensional representations of the volumetric dataset, and
reconstruct, based on the patches, the volumetric dataset.

30. (canceled)

31. The apparatus according to claim 29, wherein the one or more dynamic subpictures are placed, by the encoder, in a one-dimensional (1D) layout, wherein each of the subpictures is defined by its size.

32. The apparatus according to claim 29, further comprising:
intra subpicture predicting, by the two-dimensional video decoder, content of a subpicture of the one or more dynamic subpictures from content of at least one reference subpicture of the one or more dynamic subpictures.

33. The apparatus according to claim 29, further comprising:
inter subpicture predicting, by the two-dimensional video decoder, content of a subpicture of the one or more dynamic subpictures from content of at least one reference subpicture of dynamic subpictures associated with at least one other video frame.

34. A non-transitory computer-readable medium comprising instructions executable by at least one processor to perform a method for encoding, the method comprising:
receiving a sequence of volumetric datasets representative of dynamic volumetric data; and
encoding the sequence, the encoding comprises, for a volumetric dataset in the sequence:
generating patches including respective two-dimensional representations of the volumetric dataset,
packing the patches into one or more dynamic subpictures associated with a video frame, and
encoding, by a two-dimensional video encoder, the one or more dynamic subpictures, into a bitstream of coded video data.

35. A non-transitory computer-readable medium comprising instructions executable by at least one processor to perform a method for decoding, the method comprising:
receiving a bitstream of coded video data, coding a sequence of volumetric datasets representative of dynamic volumetric data; and
decoding the sequence, the decoding comprises, for a volumetric dataset in the sequence:
decoding, by a two-dimensional video decoder, from the bitstream one or more dynamic subpictures associated with a video frame,
extracting patches from the decoded one or more dynamic subpictures, the patches include respective two-dimensional representations of the volumetric dataset, and
reconstructing, based on the patches, the volumetric dataset.
